(19) United States
(12) Patent Application Publication
(10) Pub. No.: US 2023/0213437 A1
(43) Pub. Date: Jul. 6, 2023

(54) ZikoScope: System and method for checking color differences between varied surfaces

(71) Applicant: David Elisha, Beer Yaakov (IS)

(72) Inventor: David Elisha, Beer Yaakov (IS)

(21) Appl. No.: 17/567,111

(22) Filed: Jan. 1, 2022

(51) Int. Cl. G01N 21/25

(52) U.S. Cl. CPC G01N 21/25

(57) ABSTRACT

The present invention relates to an assembly with novel form of portable device to check color differences between varied surfaces designed for private or commercial use, and covers a wide range of applications, including. The assembly is easy to use, works well with variety of surfaces and can be used and reused efficiently with minimal training.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present disclosure is related to a method and apparatus for checking color difference between varied surfaces. More specifically, the present application is related to a method and apparatus of hand-held assembly for automated analysis of color differences between multiple surfaces.

### Description of the Related Art

The matching of a target color is highly important in a wide variety of industries, but particularly in industries requiring the matching of new paint to previously painted surfaces. The perceived color of a previously painted surface is dependent on the nature of the surface, the nature of the old paint and the pigments included therein, the lighting conditions under which the surface is observed and the limitations of the perceiving person or device. As a consequence, results can be highly variable.

Under controlled conditions, highly accurate spectrographic equipment can be used to determine spectral characteristics of a target surface color. These characteristics can be used to select a coating or paint that under similarly controlled conditions will produce a color having substantially the same spectral characteristics. However, in most instances, the use of such equipment and controlled conditions in the field (e.g., to obtain color data on a construction site or in an automotive body shop) is likely to be impracticable or prohibitively expensive. Moreover, there is no guarantee that the color that matches the target color under controlled lighting conditions will match the color under typical ambient lighting conditions.

One alternative method of matching a target surface color in the field is to place each of a series of color sample cards adjacent the surface and select what appears to be the nearest matching color. This method has the virtues of simplicity, portability and relatively low cost. However, it suffers from several sources of error including the perception of the person making the comparisons, the limited number of colors that may be compared, variance between the colors of the sample cards and the actual paint colors and variance between sample cards produced at different times by different methods.

Another method involves the hand matching of the color using actual paints. Though potentially accurate, this is obviously a highly time-consuming and expensive approach. Also, this method still requires a subjective determination of a match and is thus subject to the limitations of the perception of the person implementing the method.

Furthermore, this color variation in multiple fields is critically required. There are multiple inventions that have been proposed in prior art regarding bringing an advancement and enhanced utility regarding advancements in similar domain. However, the utilization of these systems under multiple working conditions are quite cumbersome and non-effective. Also, the features of these utility system are quite limited. Thus, there is a pronounced need in the art for methods/means for checking the color variation between multiple surfaces. The current invention aims to present portable, compact, and device capable of checking the color difference between multiple surfaces.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve devices for an advancement presenting a portable and easy to operate device for checking color differences between multiple surfaces.

It is the object of present invention to provide an assembly where there is no need of color swatches and provides instant results viewable by naked eye.

It is a more particular object of the present invention to provide an improved system which can be used for multiple industries including but not limited to advertising agencies, production lines, auto painting facilities, interior designers, architects, art supply stores and so on.

It is also the objective of invention to provide a ready to use assembly which requires minimal training and can be used immediately and does not require any calibration or reset.

It is another object of the present invention to provide a device which is easy to use and can be charged through USB jack.

Thus, it is the objective to provide a new and improved form of an advancement in easy to use and portable hardware to check color difference between multiple surfaces. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 100 is a complete view of the present disclosure.

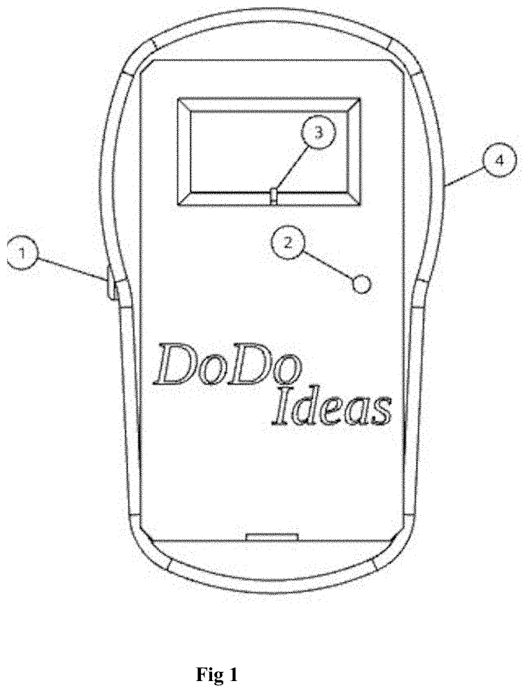

FIG. 200 shows back view of proposed assembly.

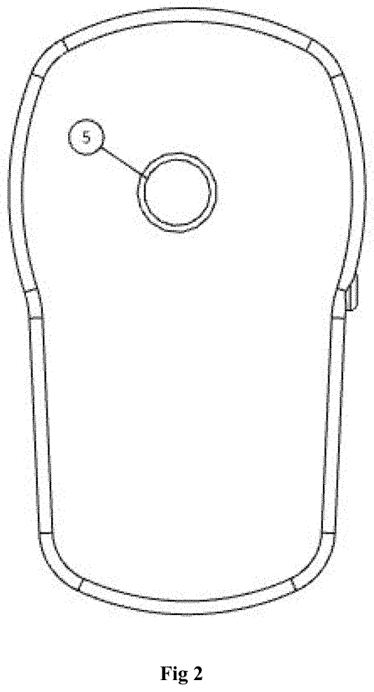

FIG. 300 shows inner view of the invention.

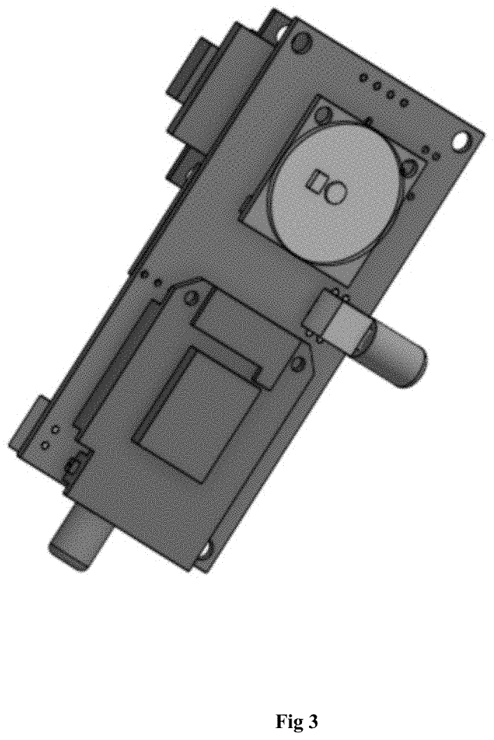

FIG. 400 shows another interior view of the invention.

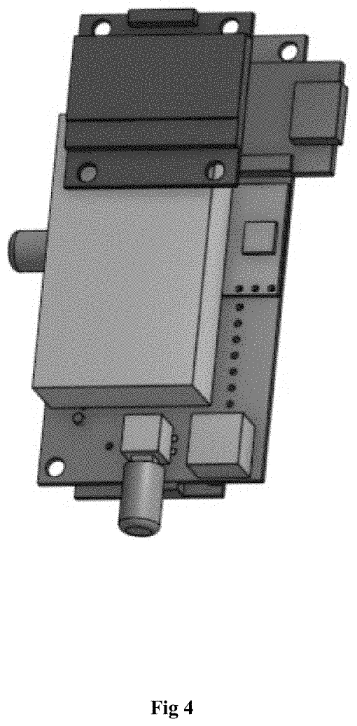

FIG. 500 shows complete back view of the invention.

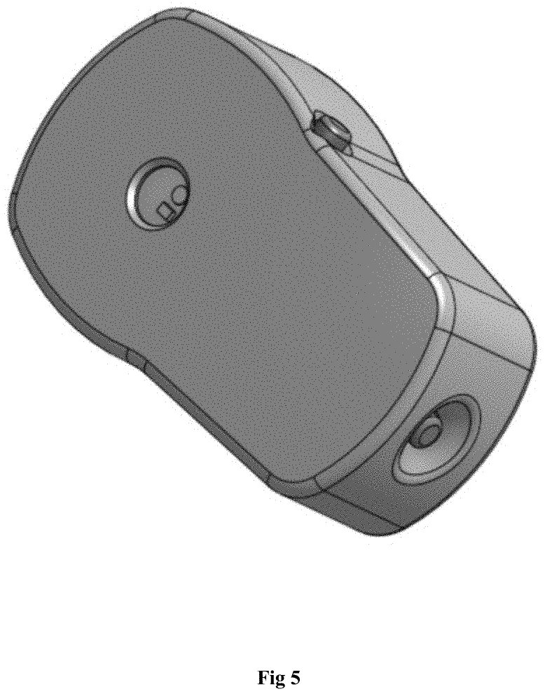

FIG. 600 shows inner back view of the invention.

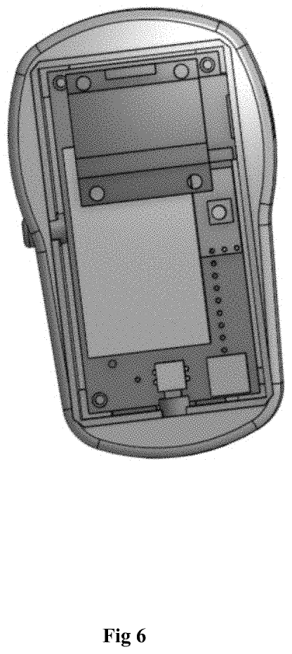

FIG. 700 shows side view of the proposed assembly.

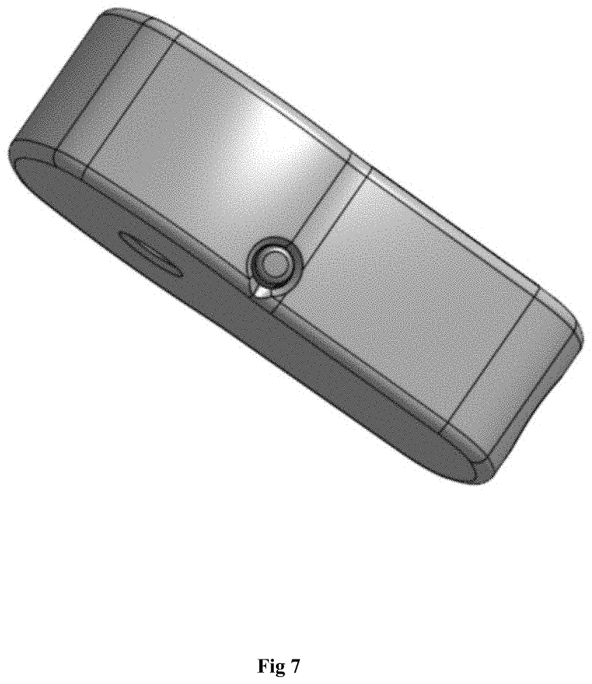

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention provides an advancement in device for checking color differences between varied surfaces.

As per embodiment of the inventive device is a portable yet easy to operate device which is ready to use. The attached drawings are showing the structure where on/off switch (1), scan push button (2), position indicator (3), USB jack (4), result indicator LED (5) and Color sensor aperture (6) is proposed.

The assembly can be operated by turning switch (1) ON which can be charged using ZikoScope with a standard C type cable until the blue LED indicator lights. To power the device, user can turn switch (1) ON, and wait until the LCD display instructs to perform the first scan. Further by placing the device on Surface A, make sure the color sensor aperture is flush with the test surface. After that user can press and then release the pushbutton (2). A blue LED will flash while “Scanning A” appears on the display. After completing the operation on Surface, A, now device will be placed on the Surface B and press the Scan pushbutton again, until “Scanning B” appears on the display, and release. After that by turning the switch (1) OFF will shut down the device.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

I: A device configured to determine the color variation between multiple devices comprising:
ON/OFF switch;
Scan pushbutton;
Position indicator;
USB jack;
Result indicator LED; and,
Color sensor aperture.

II: A method for determining the color variation between multiple surfaces comprising:
By turning the device on using on/off button (1);
Display will come on LCD;
Device placed on surface A while color sensor aperture (6) is flushed with the test surface;
Scan push button (2) is pressed;
Blue LED will flash while Scanning A appears on the display;
The device will be placed on Surface B and same process will be repeated;
Result achieved; and,
Turn Off button (1) will be pressed to complete the process.
